(19) United States
(12) Patent Application Publication
(10) Pub. No.: US 2010/0197495 A1
(43) Pub. Date: Aug. 5, 2010

(54) Synergistic Mixtures and/or Compositions With a High Fungicidal Activity

(76) Inventors: Lucio Filippini, Novara (IT); Marilena Gusmeroli, Monza (IT); Silvia Mormile, Novara (IT); Carlo Garavaglia, Cuggiono (IT); Luigi Mirenna, Milano (IT)

Correspondence Address: HEDMAN & COSTIGAN, P.C., 1230 AVENUE OF THE AMERICAS, 7th floor, NEW YORK, NY, 10020, US

(21) Appl. No.: 11/989,994

(22) PCT Filed: Aug. 4, 2006
(86) PCT No.: PCT/EP2006/007784

§ 371 Date: Mar. 5, 2008

(30) Foreign Application Priority Data
Aug. 9, 2005 (IT) MI2005A001558

(51) Int. Cl. A01N 59/26; A01P 3/00; A01P 13/00; A01P 7/00; C05G 3/02

(52) U.S. Cl. 504/101; 424/605; 424/604; 504/116.1

(57) ABSTRACT

Synergistic mixtures are described comprising at least one compound belonging to each of the following groups:
A. phosphorous acid and/or one or more salts of phosphorous acid, also called phosphites or phosphonates (defined as FOS) and
B. synergizing compounds (defined as SIN)
   and synergistic compositions comprising at least a further component having a fungicidal activity and their use for the control of phytopathogen fungi.

The present invention relates to synergistic mixtures and/or compositions with a high fungicidal activity.

As resistance phenomena can arise in nature as a result of prolonged treatment with systemic fungicides, it is always important and necessary to find synergies oriented towards anti-resistance strategies.

The Applicant has already previously found that mixtures based on at least one copper (II) salt of phosphorous acid and one or more salts of phosphorous acid obtained from metals other than copper, have a synergistic effect not only with each other, but also with products having a direct fungicidal activity, as already claimed in Italian patent application MI2005A1019. In particular, a patent object already relates to compounds of inorganic copper, known in the art and already commercialized, and/or organic molecules such as IR5885 (dipeptide compound corresponding to diastereoisomeric mixtures of methyl [S—(R,S)]-[3-(N-isopropoxycarbonylvalinyl)-amino]-3-(4-chlorophenyl)-propanoate) and IR6141 (corresponding to methyl N-(phenylacetyl)-N-2,6-xylyl-R-alaninate, described respectively in patent applications MI98A002583 and WO98/26654 A2, which exert an effective synergistic action with cupric salts of phosphorous acid and/or mixtures of its salts, as claimed in Italian patent application MI2005A1019.

The Applicant has now surprisingly found that certain products which have a zero or low direct fungicidal activity, when mixed with phosphorous acid and/or one or more salts of phosphorous acid, also called phosphites or phosphonates, are capable of unexpectedly amplifying their phytoiatric activity.

The Applicant has consequently found synergistic mixtures between products having a zero or low direct fungicidal activity and phosphorous acid and/or one or more salts of phosphorous acid, which efficiently and safely enhance the biological activity.

An object of the present invention therefore relates to synergistic mixtures comprising at least one compound belonging to each of the following groups:
A. phosphorous acid and/or one or more salts of phosphorous acid, also called phosphites or phosphonates (defined as FOS) and
B. synergizing compounds (defined as SIN).

In particular, the compounds of the FOS group are selected from phosphorous acid and/or its salts such as for example, the salt of an alkaline, alkaline earth metal, an ammonium salt or a salt of Cu, Fe, Mn, Zn, Ni, Al, Ti, Se.

The compounds of the SIN group are preferably selected from products having a zero or low direct fungicidal activity, and can therefore also belong to different chemical groups, but having intrinsic photocatalytic properties.

More specifically, the compounds of the SIN group are selected from one of the following groups a and b: a: titanium dioxide, zinc oxide or zinc salts, such as for example, zinc sulfate, zinc nitrate, zinc chloride, zinc titanate, zirconium dioxide, silica, silicic acid; b: pigments and dyes, such as for example, Prussian blue, Bengal pink, phthalocyanines, metal porphyrins, natural or synthesis optical bluing agents.

SIN compounds, group b, defined as phthalocyanines refer to compounds such as, for example, copper phthalocyanine, zinc phthalocyanine, iron phthalocyanine; SIN compounds, group b, defined as metal porphyrins refer to compounds such as, for example, chlorophyll and chlorophylline; SIN compounds, group b, defined as natural or synthesis optical bluing agents refer to compounds such as for example, esculetin, esculin, umbelliferone and stilbene derivatives.

The compounds defined as SIN are preferably applied, when solid, in micronized form with a particle-size of less than a micron and even more preferably in the form of nanoparticles or in colloidal form.

Within the spirit of this invention, the mixtures comprising more than one salt of phosphorous acid can be obtained either by mixing the single salts, or by co-precipitation of said salts in a reaction mixture; in both cases, in the above mixture, the metallic salts of phosphorous acid can be present in any proportion, solvation state, structure and composition of the crystalline lattice.

The salts of an alkaline, alkaline-earth metal, ammonium salt or salts of Fe, Mn, Zn, Ni, Al, Ti or Se, of phosphorous acid can be mono- or dibasic, or they can be mixtures of these in any proportion.

The fungicidal mixtures according to the present invention can also contain salts of alkaline metals in percentages not higher than 10% by weight, as reaction exchange salts which however do not have a direct fungicidal activity.

An object of the present invention also relates to the use of synergistic mixtures comprising at least one compound belonging to each of the following groups:
A. phosphorous acid and/or one or more salts of phosphorous acid, also called phosphites or phosphonates (defined as FOS) and
B. synergizing compounds (defined as SIN)
   as fungicidal mixtures for the control of phytopathogen fungi in agricultural crops, capable of enhancing the biological activity of the FOS compounds.

Examples of FOS compounds and SIN compounds, belonging to the subgroups a and b have already been mentioned.

In particular, the synergizing compounds SIN, when applied in a mixture with phosphorous acid and/or one or more of its salts, according to the present invention, are capable of producing a synergistic effect responsible for a surprising amplification of the biocide activity with respect to phytopathogen agents, much higher than the expected activity, as calculated by means of the Limpel formula.

The Applicant has also found that compositions of the synergistic mixtures according to the present invention, i.e. comprising at least one compound belonging to the FOS group and at least one compound belonging to the SIN group, with at least another fungicidal component, surprisingly have an additional synergistic activity. This allows the quantity of organic fungicidal product to be reduced, thus helping to minimize the environmental impact and treatment cost and improve the anti-resistance strategy.

A further object of the present patent application therefore relates to fungicidal compositions comprising synergistic mixtures according to the present invention and at least a further component with a fungicidal activity.

The component having a fungicidal activity according to the present invention is preferably selected from:
(1) IR5885, a dipeptide compound corresponding to diastereoisomeric mixtures of methyl [S—(R,S)]-[3-(N-isopropoxycarbonylvalinyl)-amino]-3-(4-chlorophenyl)propanoate in any proportion, or to one of the two diastereoisomeric forms S—R or S—S taken individually;
(2) IR6141, corresponding to methyl N-(phenylacetyl)-N-2,6-xylyl-R-alaninate;
(3) Salicylic acid (SA) or its derivatives such as acetylsalicylic acid (ASA), copper salts of salicylic acid or acetylsalicylic acid;
(4) A copper (I) or copper (II) salt, such as copper oxychloride, copper hydroxide, Bordeaux mixture, copper sulfate, or a mixture of copper hydroxide and oxychloride (Airone);
(5) Benalaxyl corresponding to methyl N-(phenylacetyl)-N-2,6-xylyl-RS-alaninate;
(6) Metalaxyl corresponding to methyl N-(2-methoxyacetyl)-N-2,6-xylyl-RS-alaninate;
(7) Metalaxyl-M corresponding to methyl N-(2-methoxyacetyl)-N-2,6-xylyl-R-alaninate;
(8) Oxadixyl corresponding to 2-methoxy-N-(2-oxo-1,3-oxazolidin-3-yl)aceto-2′,6′-xylidide;
(9) Ofurace corresponding to DL-3-[N-chloroacetyl-N-(2,6-xylyl)-amino]-γ-butyrolactone;
(10) Iprovalicarb corresponding to O-(1-methyl-ethyl)-N-[2-methyl-1-[[[1-(4-methyl-phenyl)-ethyl]amino]carbonyl]propyl]carbamate;

(11) Benthiavalicarb-isopropyl corresponding to O-isopropyl [(S)-1-{[(1R)-1-(6-fluoro-1,3-benzothiazol-2-yl)ethyl]-carbamoyl-2-methylpropyl]-carbamate;
(12) Cymoxanil corresponding to 1-(2-cyano-2-methoxyimino-acetyl)-3-ethylurea;
(13) Azoxystrobin corresponding to methyl (E)-2-[2-[6-(2-cyanophenoxy)-pyrimidin-4-yloxy]phenyl-3-methoxyacrylate;
(14) Metominofen corresponding to N-methyl-(E)-methoxyimino-(2-phenoxyphenyl)acetamide;
(15) Pyraclostrobin corresponding to methyl N-(2-[1-(4-chlorophenyl)pyrazol-3-yloxymethyl]-phenyl)-N-methoxycarbamate;
(16) Acibenzolar-S-methyl corresponding to methyl benzo(1,2,3)thiadiazole-7-thiocarboxylate;
(17) Famoxadone corresponding to 5-methyl-5-(4-phenoxyphenyl)-3-(phenylamino)oxazolidin-2,4-dione;
(18) Fenamidone corresponding to 4-methyl-4-phenyl-1-(phenylamino)-2-methylthioimidazolidin-5-one;
(19) Cyazofamide, corresponding to 2-cyano-4-chloro-5-(4-methylphenyl)-1-(N,N-dimethylaminosulfamoyl)imidazole;
(20) Fluazinam corresponding to 3-chloro-N-(3-chloro-5-trifluoromethyl-2-pyridyl)-α-α-α-trifluoro-2,6-dinitro-ρ-toluidine;
(21) Dimethomorph corresponding to (E,Z)-4-[3-(4-chlorophenyl)-3-(3,4-dimethoxyphenyl)-acryloyl]morpholine; or Flumorph (SYP-L190) corresponding to (E,Z)-4-[3-(4-fluorophenyl)-3-(3,4-dimethoxyphenyl)-acryloyl]morpholine;
(22) Flumetover corresponding to N,N-diethylamide of 4-trifluoromethyl-6-3,4-dimethoxyphenyl)-benzoic acid;
(23) Chlorothalonil corresponding to 1,3-dicyano-2,4,5-tetrachlorobenzene;
(24) Mancozeb corresponding to the manganese and zinc salt of ethylenebis(dithiocarbamate)(polymer);
(25) Tolylfluanide corresponding to N-dichlorofluoromethylthio-N′,N′-dimethyl-N-p-tolylsulfamide;
(26) Folpet corresponding to N-(trichloromethylthio)phthalimide;
(27) Etridiazole corresponding to ethyl-3-trichloromethyl-1,2,4-thiadiazolyl ether;
(28) Hymexanol corresponding to 5-methyliso-oxazol-3-ol;
(29) Propamocarb corresponding to propyl-(3-dimethylaminopropyl)carbamate;
(30) R-3-aminobutanoic acid or RS-3-aminobutanoic acid;
(31) Zoxamide, corresponding to 3,5-dichloro-N-(3-chloro-1-ethyl-1-methyl-2-oxopropyl)-p-toluamide;
(32) 2-(4-chlorophenyl)-N-[2-(3-methoxy-4-prop-2-inyloxy-phenyl)ethyl]-2-prop-2-inyloxy-acetamide;
(33) Ethaboxam, (RS)-(α-cyano-2-thienyl)-4-ethyl-2(ethylamino)-5-thiazolecarboxyamide.

The compounds (1) are described in Italian patent application Nr. MI98A002583.

Compound (2) is described in patent application WO 98/26654 A2.

The compounds (3) are commercial products and their copper salts are described in Italian patent application Nr. MI 2001A002430.

The compounds (4) are easily available on the market.

Compound (5) is described in “The Pesticide Manual”, 1983, VIIth edition, British Crop Protection Council Ed., page 32.

Compound (6) is described in English patent GB 1,500,581.

Compound (7) is described in patent application WO 96/01559 A1.

Compound (8) is described in English patent GB 2,058,059.

Compound (9) is described in “Phytopathological News” (1978), Vol. 9, page 142.

Compound (10) is described in patent application EP 550,788 and EP 775,696.

Compound (11) is described in patent application EP 775,696.

Compound (12) is described in “The Pesticide Manual”, 1983, VIIth edition, British Crop Protection Council Ed., page 148.

Compound (13) is described in European patent application EP 382,375.

Compound (14), corresponding to the experimental abbreviation SSF-126, is described in the U.S. Pat. No. 5,185,242.

Compound (15) is described in patent application WO 96/01258.

Compound (16) is described in the U.S. Pat. No. 4,931,581.

Compound (17) is described in “Brighton Crop Protection Conference-Pests and Diseases” 1996, Congress Records.

Compound (18) is described in European patent application EP 629,616.

Compound (19), also called IKF916, is described in European patent application EP 705,823.

Compound (20) is described in European patent application EP 31,257.

The compounds (21) are described respectively in European patent application EP 219,756 and in “Brighton Crop Protection Conference-Pests and Diseases” 2000, Congress Records.

Compound (22) is described in European patent applications EP 360,701 and EP 611,232.

Compound (23) is described in “The Pesticide Manual”, 1983, VIIth edition, British Crop Protection Council Ed., page 120.

Compound (24) is described in “The Pesticide Manual”, 1983, VIIth edition, British Crop Protection Council Ed., page 339.

Compound (25) is described in “The Pesticide Manual”, 1983, VIIth edition, British Crop Protection Council Ed., page 537.

Compound (26) is described in “The Pesticide Manual”, 1983, VIIth edition, British Crop Protection Council Ed., page 599.

Compound (27) is described in “The Pesticide Manual”, 1983, VIIth edition, British Crop Protection Council Ed., page 252.

Compound (28) is described in “The Pesticide Manual”, 1983, VIIth edition, British Crop Protection Council Ed., page 314.

Compound (29) is described in “The Pesticide Manual”, 1983, VIIth edition, British Crop Protection Council Ed., page 471.

Compound (30) is described in European patent application EP 753,258.

Compound (31) is described in “Brighton Crop Protection Conference-Pests and Diseases” 1998, Congress Records.

Compound (32) is described in patent application WO 01/87822.

Compound (33) is described in “The e-Pesticide Manual”, 2003, XIIIth edition, British Crop Protection Council Ed.

Examples of preferred fungicidal mixtures according to the present invention are the following:
M1: phosphorous acid+titanium dioxide;
M2: phosphorous acid+Prussian blue;
M3: phosphorous acid+zinc oxide;
M4: copper (II) salt of phosphorous acid+titanium dioxide;
M5: copper (II) salt of phosphorous acid+zinc oxide;
M6: copper (II) salt of phosphorous acid+zirconium dioxide;
M7: copper (II) salt of phosphorous acid+silica;
M8: copper (II) salt of phosphorous acid+silicic acid;
M9: copper (II) salt of phosphorous acid+esculin;
M10: copper (II) salt of phosphorous acid+copper phthalocyanine;
M11: copper (II) salt of phosphorous acid+Prussian blue;
M12: copper (II) salt of phosphorous acid+titanium dioxide+Prussian blue;
M13: copper (II) salt of phosphorous acid+zinc oxide+Prussian blue;
M14: zinc salt of phosphorous acid+titanium dioxide;
M15: zinc salt of phosphorous acid+zinc oxide;
M16: zinc salt of phosphorous acid+zirconium dioxide;
M17: zinc salt of phosphorous acid+silica;
M18: zinc salt of phosphorous acid+silicic acid;
M19: zinc salt of phosphorous acid+esculin;
M20: zinc salt of phosphorous acid+copper phthalocyanine;
M21: zinc salt of phosphorous acid+Prussian blue;
M22: copper (II) salt of phosphorous acid+calcium salt of phosphorous acid+titanium dioxide;
M23: copper (II) salt of phosphorous acid+manganese (II) salt of phosphorous acid+titanium dioxide;
M24: copper (II) salt of phosphorous acid+zinc salt of phosphorous acid+titanium dioxide;
M25: copper (II) salt of phosphorous acid+ammonium salt of phosphorous acid+titanium dioxide;
M26: copper (II) salt of phosphorous acid+calcium salt of phosphorous acid+zinc oxide;
M27: copper (II) salt of phosphorous acid+manganese (II) salt of phosphorous acid+zinc oxide;
M28: copper (II) salt of phosphorous acid+zinc salt of phosphorous acid+zinc oxide;
M29: copper (II) salt of phosphorous acid+ammonium salt of phosphorous acid+zinc oxide;
M30: copper (II) salt of phosphorous acid+calcium salt of phosphorous acid+zirconium dioxide;
M31: copper (II) salt of phosphorous acid+zinc salt of phosphorous acid+zirconium dioxide;
M32: copper (II) salt of phosphorous acid+manganese (II)salt of phosphorous acid+zirconium dioxide;
M33: copper (II) salt of phosphorous acid+calcium salt of phosphorous acid+Prussian blue;
M34: copper (II) salt of phosphorous acid+zinc salt of phosphorous acid+Prussian blue;
M35: copper (II) salt of phosphorous acid+manganese (II) salt of phosphorous acid+Prussian blue;
M36: copper (II) salt of phosphorous acid+zinc salt of phosphorous acid+Prussian blue+titanium dioxide;
M37: copper (II) salt of phosphorous acid+calcium salt of phosphorous acid+Prussian blue+titanium dioxide;
M38: copper (II) salt of phosphorous acid+manganese(II) salt of phosphorous acid+Prussian blue+titanium dioxide;
M39: copper (II) salt of phosphorous acid+zinc salt of phosphorous acid+Prussian blue+zinc oxide;
M40: copper (II) salt of phosphorous acid+calcium salt of phosphorous acid+Prussian blue+zinc oxide;
M41: copper (II) salt of phosphorous acid+manganese (II) salt of phosphorous acid+Prussian blue+zinc oxide;
M42: copper (II) salt of phosphorous acid+calcium salt of phosphorous acid+copper phthalocyanine;
M43: copper (II) salt of phosphorous acid+zinc salt of phosphorous acid+copper phthalocyanine;
M44: copper (II) salt of phosphorous acid+manganese (II) salt of phosphorous acid+copper phthalocyanine;
M45: copper (II) salt of phosphorous acid+calcium salt of phosphorous acid+esculin;
M46: copper (II) salt of phosphorous acid+zinc salt of phosphorous acid+esculin;
M47: copper (II) salt of phosphorous acid+manganese (II) salt of phosphorous acid+esculin;

The mixtures M4, M5, M8, M11, M12, M13, M14, M18, M21, M22, M24, M26, M28, M34, M36, M37, M43, M47 of the above list are particularly preferred.

Examples of preferred fungicidal compositions according to the present invention are the following:
1. IR5885+copper (II) salt of phosphorous acid+titanium dioxide;
2. IR5885+copper (II) salt of phosphorous acid+zinc oxide;
3. IR5885+copper (II) salt of phosphorous acid+zirconium dioxide;
4. IR5885+copper (II) salt of phosphorous acid+silica;
5. IR5885+copper (II) salt of phosphorous acid+silicic acid;
6. IR5885+copper (II) salt of phosphorous acid+esculin;
7. IR5885+copper (II) salt of phosphorous acid+copper phthalocyanine;
8. IR5885+copper (II) salt of phosphorous acid+Prussian blue;
9. IR5885+zinc salt of phosphorous acid+titanium dioxide;
10. IR5885+zinc salt of phosphorous acid+zinc oxide;
11. IR5885+zinc salt of phosphorous acid+zirconium dioxide;
12. IR5885+zinc salt of phosphorous acid+silica;
13. IR5885+zinc salt of phosphorous acid+silicic acid;
14. IR5885+zinc salt of phosphorous acid+esculin;
15. IR5885+zinc salt of phosphorous acid+copper phthalocyanine;
16. IR5885+zinc salt of phosphorous acid+Prussian blue;
17. IR5885+copper (II) salt of phosphorous acid+calcium salt of phosphorous acid+titanium dioxide;
18. IR5885+copper (II) salt of phosphorous acid+manganese (II) salt of phosphorous acid+titanium dioxide;
19. IR5885+copper (II) salt of phosphorous acid+zinc salt of phosphorous acid+titanium dioxide;
20. IR5885+copper (II) salt of phosphorous acid+ammonium salt of phosphorous acid+titanium dioxide;
21. IR5885+copper (II) salt of phosphorous acid+calcium salt of phosphorous acid+zinc oxide;
22. IR5885+copper (II) salt of phosphorous acid+manganese (II) salt of phosphorous acid+zinc oxide;
23. IR5885+copper (II) salt of phosphorous acid+zinc salt of phosphorous acid+zinc oxide;
24. IR5885+copper (II) salt of phosphorous acid+ammonium salt of phosphorous acid+zinc oxide;
25. IR5885+copper (II) salt of phosphorous acid+calcium salt of phosphorous acid+zirconium dioxide;
26. IR5885+copper (II) salt of phosphorous acid+zinc salt of phosphorous acid+zirconium dioxide;
27. IR5885+copper (II) salt of phosphorous acid+manganese (II) salt of phosphorous acid+zirconium dioxide;
28. IR5885+copper (II) salt of phosphorous acid+calcium salt of phosphorous acid+Prussian blue;
29. IR5885+copper (II) salt of phosphorous acid+zinc salt of phosphorous acid+Prussian blue;
30. IR5885+copper (II) salt of phosphorous acid+manganese (II) salt of phosphorous acid+Prussian blue;
31. IR5885+copper (II) salt of phosphorous acid+zinc salt of phosphorous acid+Prussian blue+titanium dioxide;
32. IR5885+copper (II) salt of phosphorous acid+calcium salt of phosphorous acid+Prussian blue+titanium dioxide;
33. IR5885+copper (II) salt of phosphorous acid+manganese (II) salt of phosphorous acid+Prussian blue+titanium dioxide;
34. IR5885+copper (II) salt of phosphorous acid+zinc salt of phosphorous acid+Prussian blue+zinc oxide;
35. IR5885+copper (II) salt of phosphorous acid+calcium salt of phosphorous acid+Prussian blue+zinc oxide;
36. IR5885+copper (II) salt of phosphorous acid+manganese (II) salt of phosphorous acid+Prussian blue+zinc oxide;
37. IR5885+copper (II) salt of phosphorous acid+calcium salt of phosphorous acid+copper phthalocyanine;
38. IR5885+copper (II) salt of phosphorous acid+zinc salt of phosphorous acid+copper phthalocyanine;
39. IR5885+copper (II) salt of phosphorous acid+manganese (II) salt of phosphorous acid+copper phthalocyanine;
40. IR5885+copper (II) salt of phosphorous acid+calcium salt of phosphorous acid+esculin;
41. IR5885+copper (II) salt of phosphorous acid+zinc salt of phosphorous acid+esculin;
42. IR5885+copper (II) salt of phosphorous acid+manganese (II) salt of phosphorous acid+esculin;
43. IR5885+copper (II) salt of phosphorous acid+titanium dioxide+Prussian blue;
44. IR5885+copper (II) salt of phosphorous acid+zinc oxide+Prussian blue;
45. IR6141+copper (II) salt of phosphorous acid+titanium dioxide;
46. IR6141+copper (II) salt of phosphorous acid+zinc oxide;
47. IR6141+copper (II) salt of phosphorous acid+zirconium dioxide;
48. IR6141+copper (II) salt of phosphorous acid+silica;
49. IR6141+copper (II) salt of phosphorous acid+silicic acid;
50. IR6141+copper (II) salt of phosphorous acid+esculin;
51. IR6141+copper (II) salt of phosphorous acid+copper phthalocyanine;
52. IR6141+copper (II) salt of phosphorous acid+Prussian blue;
53. IR6141+zinc salt of phosphorous acid+titanium dioxide;
54. IR6141+zinc salt of phosphorous acid+zinc oxide;
55. IR6141+zinc salt of phosphorous acid+zirconium dioxide;
56. IR6141+zinc salt of phosphorous acid+silica;
57. IR6141+zinc salt of phosphorous acid+silicic acid;
58. IR6141+zinc salt of phosphorous acid+esculin;
59. IR6141+zinc salt of phosphorous acid+copper phthalocyanine;
60. IR6141+zinc salt of phosphorous acid+Prussian blue;
61. IR6141+copper (II) salt of phosphorous acid+calcium salt of phosphorous acid+titanium dioxide;
62. IR6141+copper (II) salt of phosphorous acid+manganese (II) salt of phosphorous acid+titanium dioxide;
63. IR6141+copper (II) salt of phosphorous acid+zinc salt of phosphorous acid+titanium dioxide;
64. IR6141+copper (II) salt of phosphorous acid+ammonium salt of phosphorous acid+titanium dioxide;
65. IR6141+copper (II) salt of phosphorous acid+calcium salt of phosphorous acid+zinc oxide;
66. IR6141+copper (II) salt of phosphorous acid+manganese (II) salt of phosphorous acid+zinc oxide;
67. IR6141+copper (II) salt of phosphorous acid+zinc salt of phosphorous acid+zinc oxide;
68. IR6141+copper (II) salt of phosphorous acid+ammonium salt of phosphorous acid+zinc oxide;
69. IR6141+copper (II) salt of phosphorous acid+calcium salt of phosphorous acid+zirconium dioxide;
70. IR6141+copper (II) salt of phosphorous acid+zinc salt of phosphorous acid+zirconium dioxide;
71. IR6141+copper (II) salt of phosphorous acid+manganese (II) salt of phosphorous acid+zirconium dioxide;
72. IR6141+copper (II) salt of phosphorous acid+calcium salt of phosphorous acid+Prussian blue;
73. IR6141+copper (II) salt of phosphorous acid+zinc salt of phosphorous acid+Prussian blue;
74. IR6141+copper (II) salt of phosphorous acid+manganese (II) salt of phosphorous acid+Prussian blue;
75. IR6141+copper (II) salt of phosphorous acid+zinc salt of phosphorous acid+Prussian blue+titanium dioxide;
76. IR6141+copper (II) salt of phosphorous acid+calcium salt of phosphorous acid+Prussian blue+titanium dioxide;
77. IR6141+copper (II) salt of phosphorous acid+manganese (II) salt of phosphorous acid+Prussian blue+titanium dioxide;
78. IR6141+copper (II) salt of phosphorous acid+zinc salt of phosphorous acid+Prussian blue+zinc oxide;
79. IR6141+copper (II) salt of phosphorous acid+calcium salt of phosphorous acid+Prussian blue+zinc oxide;
80. IR6141+copper (II) salt of phosphorous acid+manganese (II) salt of phosphorous acid+Prussian blue+zinc oxide;
81. IR6141+copper (II) salt of phosphorous acid+calcium salt of phosphorous acid+copper phthalocyanine;
82. IR6141+copper (II) salt of phosphorous acid+zinc salt of phosphorous acid+copper phthalocyanine;
83. IR6141+copper (II) salt of phosphorous acid+manganese (II) salt of phosphorous acid+copper phthalocyanine;
84. IR6141+copper (II) salt of phosphorous acid+calcium salt of phosphorous acid+esculin;
85. IR6141+copper (II) salt of phosphorous acid+zinc salt of phosphorous acid+esculin;
86. IR6141+copper (II) salt of phosphorous acid+manganese (II) salt of phosphorous acid+esculin;
87. Cu(ASA)₂+copper (II) salt of phosphorous acid+titanium dioxide;
88. Cu(ASA)₂+copper (II) salt of phosphorous acid+zinc oxide;
89. Cu(ASA)₂+copper (II) salt of phosphorous acid+zirconium dioxide;
90. Cu(ASA)₂+copper (II) salt of phosphorous acid+silica;
91. Cu(ASA)₂+copper (II) salt of phosphorous acid+silicic acid;
92. Cu(ASA)₂+copper (II) salt of phosphorous acid+esculin;
93. Cu(ASA)₂+copper (II) salt of phosphorous acid+copper phthalocyanine;
94. Cu(ASA)₂+copper (II) salt of phosphorous acid+Prussian blue;
95. Cu(ASA)₂+zinc salt of phosphorous acid+titanium dioxide;
96. Cu(ASA)₂+zinc salt of phosphorous acid+zinc oxide;
97. Cu(ASA)₂+zinc salt of phosphorous acid+zirconium dioxide;
98. Cu(ASA)₂+zinc salt of phosphorous acid+silica;
99. Cu(ASA)₂+zinc salt of phosphorous acid+silicic acid;
100. Cu(ASA)₂+zinc salt of phosphorous acid+esculin;
101. Cu(ASA)₂+zinc salt of phosphorous acid+copper phthalocyanine;
102. Cu(ASA)₂+zinc salt of phosphorous acid+Prussian blue;
103. Cu(ASA)₂+copper (II) salt of phosphorous acid+calcium salt of phosphorous acid+titanium dioxide;
104. Cu(ASA)₂+copper (II) salt of phosphorous acid+manganese (II) salt of phosphorous acid+titanium dioxide;
105. Cu(ASA)₂+copper (II) salt of phosphorous acid+zinc salt of phosphorous acid+titanium dioxide;
106. Cu(ASA)₂+copper (II) salt of phosphorous acid+ammonium salt of phosphorous acid+titanium dioxide;
107. Cu(ASA)₂+copper (II) salt of phosphorous acid+calcium, salt of phosphorous acid+zinc oxide;
108. Cu(ASA)₂+copper (II) salt of phosphorous acid+manganese (II) salt of phosphorous acid+zinc oxide;
109. Cu(ASA)₂+copper (II) salt of phosphorous acid+zinc salt of phosphorous acid+zinc oxide;
110. Cu(ASA)₂+copper (II) salt of phosphorous acid+ammonium salt of phosphorous acid+zinc oxide;
111. Cu(ASA)₂+copper (II) salt of phosphorous acid+calcium salt of phosphorous acid+zirconium dioxide;
112. Cu(ASA)₂+copper (II) salt of phosphorous acid+zinc salt of phosphorous acid+zirconium dioxide;
113. Cu(ASA)₂+copper (II) salt of phosphorous acid+manganese (II) salt of phosphorous acid+zirconium dioxide;
114. Cu(ASA)₂+copper (II) salt of phosphorous acid+calcium salt of phosphorous acid+Prussian blue;
115. Cu(ASA)₂+copper (II) salt of phosphorous acid+zinc salt of phosphorous acid+Prussian blue;
116. Cu(ASA)₂+copper (II) salt of phosphorous acid+manganese (II) salt of phosphorous acid+Prussian blue;
117. Cu(ASA)₂+copper (II) salt of phosphorous acid+zinc salt of phosphorous acid+Prussian blue+titanium dioxide;
118. Cu(ASA)₂+copper (II) salt of phosphorous acid+calcium salt of phosphorous acid+Prussian blue+titanium dioxide;
119. Cu(ASA)₂+copper (II) salt of phosphorous acid+manganese (II) salt of phosphorous acid+Prussian blue+titanium dioxide;
120. Cu(ASA)₂+copper (II) salt of phosphorous acid+zinc salt of phosphorous acid+Prussian blue+zinc oxide;
121. Cu(ASA)₂+copper (II) salt of phosphorous acid+calcium salt of phosphorous acid+Prussian blue+zinc oxide;
122. Cu(ASA)₂+copper (II) salt of phosphorous acid+manganese (II) salt of phosphorous acid+Prussian blue+zinc oxide;
123. Cu(ASA)₂+copper (II) salt of phosphorous acid+calcium salt of phosphorous acid+copper phthalocyanine;
124. Cu(ASA)₂+copper (II) salt of phosphorous acid+zinc salt of phosphorous acid+copper phthalocyanine;
125. Cu(ASA)₂+copper (II) salt of phosphorous acid+manganese (II) salt of phosphorous acid+copper phthalocyanine;
126. Cu(ASA)₂+copper (II) salt of phosphorous acid+calcium salt of phosphorous acid+esculin;
127. Cu(ASA)₂+copper (II) salt of phosphorous acid+zinc salt of phosphorous acid+esculin;
128. Cu(ASA)₂+copper (II) salt of phosphorous acid+manganese (II) salt of phosphorous acid+esculin;
129. Cu(ASA)₂+copper (II) salt of phosphorous acid+Prussian blue+titanium dioxide;
130. Cu(ASA)₂+copper (II) salt of phosphorous acid+Prussian blue+zinc oxide;
131. Cu(SA)+copper (II) salt of phosphorous acid+titanium dioxide;
132. Cu(SA)+copper (II) salt of phosphorous acid+zinc oxide;
133. Cu(SA)+copper (II) salt of phosphorous acid+zirconium dioxide;
134. Cu(SA)+copper (II) salt of phosphorous acid+silica;
135. Cu(SA)+copper (II) salt of phosphorous acid+silicic acid;
136. Cu(SA)+copper (II) salt of phosphorous acid+esculin;
137. Cu(SA)+copper (II) salt of phosphorous acid+copper phthalocyanine;
138. Cu(SA)+copper (II) salt of phosphorous acid+Prussian blue;
139. Cu(SA)+zinc salt of phosphorous acid+titanium dioxide;
140. Cu(SA)+zinc salt of phosphorous acid+zinc oxide;
141. Cu(SA)+zinc salt of phosphorous acid+zirconium dioxide;
142. Cu(SA)+zinc salt of phosphorous acid+silica;
143. Cu(SA)+zinc salt of phosphorous acid+silicic acid;
144. Cu(SA)+zinc salt of phosphorous acid+esculin;
145. Cu(SA)+zinc salt of phosphorous acid+copper phthalocyanine;
146. Cu(SA)+zinc salt of phosphorous acid+Prussian blue;
147. Cu(SA)+copper (II) salt of phosphorous acid+calcium salt of phosphorous acid+titanium dioxide;
148. Cu(SA)+copper (II) salt of phosphorous acid+manganese (II) salt of phosphorous acid+titanium dioxide;
149. Cu(SA)+copper (II) salt of phosphorous acid+titanium dioxide+Prussian blue;
150. Cu(SA)+copper (II) salt of phosphorous acid+zinc oxide+Prussian blue;
151. Cu(SA)+copper (II) salt of phosphorous acid+zinc salt of phosphorous acid+titanium dioxide+Prussian blue.

Particularly preferred are the fungicidal compositions 1., 2., 7., 8., 10., 17., 19., 21., 32., 43., 44., 46., 51., 60., 78., 79., 87., 88., 91., 93., 94., 95., 102., 103., 105., 107., 114., 117., 123., 125., 127., 129., 130., 131., 132., 134., 135., 137., 139., 143., 147., 149., 150., 151. of the above list.

SIN compounds are commercial products; FOS compounds can be synthesized by means of the methods known in literature or according to the procedures described in Italian patent application MI2005A1019.

An object of the present invention also relates to a method for controlling phytopathogen fungi in agricultural crops by the application of the synergistic mixtures comprising at least one compound belonging to each of the following groups:
A. phosphorous acid and/or one or more salts of phosphorous acid, also called phosphites or phosphonates (defined as FOS) and
B. synergizing compounds (defined as SIN)
   or by the application of synergistic compositions comprising said mixtures and one or more fungicidal compounds (1)-(33).

The mixtures and/or synergistic compositions according to the present invention allow numerous fungal and bacterial phytopathogens and viruses to be controlled.

More specifically, the compositions or mixtures according to the present invention have a particularly high fungicidal activity against phytopathogen fungi which attack crops of vines, tobacco, sugar beet, cereals, vegetables, rice, cucurbits, fruit trees.

Examples of phytopathogen fungi which can be effectively fought with this technology are:
Erysiphe spp. on cereals;
Puccinia spp. on cereals;
Plasmopara viticola on vines;
Pythium spp. on vegetables;
Phytophthora spp. on vegetables;
Peronospora tabacina on tabacco;
Septoria spp. on cereals;
Sphaerotheca fuliginea on cucurbits (for example cucumbers);
Pseudoperonospora cubensis on cucurbits;
Pyricularia oryzae on rice;
Uncinula necator on vines;
Venturia spp. on fruit trees;
Botrytis cinerea on vines and vegetables;
Fusarium spp. on cereals;
Alternaria spp. on fruit trees and vegetables;
Bremia on salads and spinach.

These compositions or mixtures according to the present invention are capable of exerting a fungicidal action for both treatment and prevention.

In order to obtain the desired effect, the applicative quantity of each compound selected from those defined as FOS and SIN, and optionally one or more further fungicidal compounds (1)-(33), can vary in relation to various factors such as, for example, the compounds used, the crop to be preserved, the type of pathogen, the degree of infection, the climatic conditions, the application method and the formulation adopted.

For the compounds defined as FOS and SIN, as also for any possible further fungicides (1)-(33), doses ranging from 0.5 g to 5 kg per hectare generally provide a sufficient control.

The reciprocal percentage ratio between the compounds defined as FOS and SIN can therefore vary from 0.0001% to 99.9999%.

The application of these compositions or mixtures can be effected on all parts of the plant, for example on the leaves, stems, branches and roots, or on the seeds themselves before sowing, or on the ground in which the plant grows.

For practical use in agriculture, the mixtures or compositions can be suitably formulated in the form of dry powders, wettable powders, emulsifying concentrates, micro-emulsions, pastes, granulates, solutions, suspensions, etc.: the choice of the type of formulation will depend on the specific use.

The formulations are prepared in the known way, for example by diluting or dissolving the active substance(s) with a solvent medium and/or a solid diluent, possibly in the presence of surface-active agents.

Solid diluents or supports which can be used are, for example: silica, kaolin, bentonite, talc, infusorial earth, dolomite, calcium carbonate, magnesia, gypsum, clays, synthetic silicates, attapulgite, sepiolite.

Liquid diluents which can be used, are for example: water, aromatic or paraffinic organic solvents, alcohols, esters, ketones, amides.

Sodium salts, potassium salts, calcium salts, triethanolamine salts of: alkylnaphthalenesulphonates, condensed alkylnaphthalenesulphonates, phenylsulphonates, polycarboxylates, alkylsulphosuccinates, sulphosuccinates, alkylsulphates, ligninsulphates, polyethoxylated fatty alcohols, alkylarylsulphonates, polyethoxylated alkylphenols, polyethoxylated esters of sorbitol, polypropoxy polyethoxylates (block polymers), can be used as surface-active agents.

Special additives for particular purposes can also be added to the formulations of the mixtures or compositions, object of the present invention, such as for example, antifreeze agents such as propylene glycol, or adhesive agents, such as gum Arabic, polyvinyl alcohol, polyvinyl pyrrolidone, etc.

If necessary, it is possible to add other compatible active principles to the compositions or mixtures cited above such as, for example other fungicides, phytoregulators, antibiotics, herbicides, insecticides and fertilizers.

The concentration of active principle(s) in the above compositions and mixtures can vary within a wide range in relation to the active compound, the applications for which they are destined, the environmental conditions and the type of formulation adopted.

The concentration of active principle(s) generally ranges from 1% to 90%, preferably from 5 to 50%.

The following examples of the application method according to the present invention are provided for illustrative and non-limiting purposes of the present invention.

### EXAMPLE 1

Efficacy of the mixtures of one or more compounds belonging to the FOS and SIN groups of compounds in the control of Plasmopara viticola on vines in preventive leaf application (greenhouse test) (Table 1-Table 3) and of the compositions of said mixtures with a further fungicidal component (Table 4).

Leaves of cultivar Merlot vines, grown in vases, in a conditioned environment (20±1° C., 70% relative humidity) are treated by spraying both sides of the leaves with the mixtures under examination dispersed in an aqueous solution containing a 0.3% of tween 20.

After remaining 7 days in a conditioned environment, the plants are infected on the lower side with an aqueous suspension of spores of Plasmopara viticola (200,000 spores per cm³).

The plants are kept in a humidity saturated environment, at 21° C., for the incubation period of the fungus and, at the end of this period (7 days), the fungicidal activity is evaluated according to an evaluation percentage scale from 100 (healthy plant) to 0 (completely infected plant).

From the data indicated in tables 1, it is possible to verify the synergistic effect of the mixtures, consisting of the mixtures being examined, compared with the expected efficacy using the Limpel formula (“Pesticide Science” (1987), vol. 19, pages 309-315):

E =x+y−(x y/100)

wherein:
E is the fungicidal activity expected, in the absence of synergistic effects, from a mixture obtained by mixing g.x of compound X with g.y of compound Y;
x is the activity of compound X when used alone with a dosage of g.x;
y is the activity of compound Y when used alone with a dosage of g.y.

When the fungicidal activity found experimentally is greater than the value of E, this activity is considered a synergistic effect.

TABLE 1
7-day preventive activity on Plasmopara viticola of mixtures of
titanium dioxide**, which at 250 ppm (g · x) is 13 (x).

| | | | Activity | | |
|---|---|---|---|---|---|
| | Dose | | Mixture | Experimental | |
| | ppm* | Activity | according to | activity of | Synergy |
| Compound | (g · y) | (y) | Limpel (E) | mixture | factor |
| CuHPO₃ | 250 | 55 | 60.8 | 90 | 1.47 |
| ZnHPO₃ | 250 | 35 | 43.4 | 70 | 1.61 |
| CuHPO₃ + | 250 | 50 | 56.5 | 99 | 1.75 |
| CaHPO₃ | | | | | |
| (50:50) | | | | | |
| CuHPO₃ + | 250 | 52 | 58.2 | 98 | 1.68 |
| ZnHPO₃ | | | | | |
| (50:50) | | | | | |
| CuHPO₃ + | 250 | 47 | 53.9 | 82 | 1.54 |
| MnHPO₃ | | | | | |
| (50:50) | | | | | |
| CuHPO₃ + | 250 | 52 | 58.3 | 87 | 1.49 |
| MnHPO₃ | | | | | |
| (66:34) | | | | | |

*the doses in ppm and the relative ratios refer to the quantity of equivalent phosphorous acid.
**the titanium dioxide used has a maximum particle-size of 0.15 microns.

TABLE 2
7-day preventive activity on Plasmopara viticola of mixtures of
copper (II) phosphite, which at 250 ppm, referring to the quantity
of equivalent phosphorous acid, (g · x) is 55 (x).

| | | | Activity | | |
|---|---|---|---|---|---|
| | Dose | | Mixture | Experimental | |
| SIN | ppm | Activity | according to | activity of | Synergy |
| Compound* | (g · y) | (y) | Limpel (E) | mixture | factor |
| TiO₂ | 250 | 13 | 60.8 | 90 | 1.47 |
| ZnO | 250 | 30 | 68.5 | 94 | 1.37 |
| Prussian blue | 250 | 32 | 69.4 | 92 | 1.33 |
| Silicic acid | 14** | 14 | 61.3 | 88 | 1.44 |
| Cu(II) phtha- | 32** | 10 | 59.5 | 90 | 1.51 |
| locyanine | | | | | |
| Esculin | 25 | 10 | 59.5 | 87 | 1.46 |

*the compounds of the SIN group have a maximum particle-size of 0.15 microns.
**the dose in ppm refers to the quantity of equivalent metal.

TABLE 3
7-day preventive activity on Plasmopara viticola of ternary
mixtures:

| | | Experimental activity |
|---|---|---|
| | | % of mixture (arithmetical |
| | | sum of the |
| | Dose (% activity) of each | contribution of each |
| Mixtures | single compound | component) |
| CuHPO₃ + *TiO₂ + | CuHPO₃: 250 ppm** (55) | 100 (60) |
| Prussian blue | TiO₂: 125 ppm (3) | |
| | Prussian blue: 125 ppm (5) | |
| CuHPO₃ + *ZnO + | CuHPO₃: 250 ppm** (55) | 100 (74) |
| Prussian blue | ZnO: 125 ppm (14) | |
| | Prussian blue: 125 ppm (5) | |
| CuHPO₃ + CaHPO₃ (1:1) | CuHPO₃ + CaHPO₃: 250 ppm** | 100 (58) |
| *TiO₂ + Prussian blue | (50) | |
| | TiO₂: 125 ppm (3) | |
| | Prussian blue: 125 ppm (5) | |

*The oxides used have a maximum particle-size of 0.15 microns.
**the dose is expressed in ppm of equivalent phosphorous acid.

TABLE 4
7-day preventive activity on Plasmopara viticola of the
compositions consisting of the previous mixtures with an-
other fungicidal component:

| | | Experimental activity |
|---|---|---|
| | | % of mixture (arithmetical |
| | | sum of the |
| | Dose (% activity) of each | contribution of each |
| Compositions | single compound | component) |
| IR5885 + CuHPO₃ + | IR5885: 0.45 ppm (41) | 100 (76) |
| *TiO₂ | CuHPO₃: 125 ppm** (32) | |
| | TiO₂: 125 ppm (3) | |
| IR5885 + CuHPO₃ + | IR5885: 0.45 ppm (41) | 100 (87) |
| *ZnO | CuHPO₃: 125 ppm** (32) | |
| | ZnO: 125 ppm (14) | |
| IR5885 + CuHPO₃ + | IR5885: 0.45 ppm (41) | 100 (74) |
| CaHPO₃ (1:1) *TiO₂ | CuHPO₃ + CaHPO₃: 125 ppm** | |
| | (30) | |
| | TiO₂: 125 ppm (3) | |
| IR5885 + CuHPO₃ + | IR5885: 0.45 ppm (41) | 100 (81) |
| *TiO₂ + Prussian blue | CuHPO₃: 125 ppm** (32) | |
| | TiO₂: 125 ppm (3) | |
| | Prussian blue: 125 ppm (5) | |
| IR5885 + CuHPO₃ + | IR5885: 0.45 ppm (41) | 100 (92) |
| *ZnO + Prussian blue | CuHPO₃: 125 ppm** (32) | |
| | ZnO: 125 ppm (14) | |
| | Prussian blue: 125 ppm (5) | |
| IR5885 + CuHPO₃ + Ca—HPO₃ | IR5885: 0.45 ppm (41) | 100 (79) |
| (1:1) *TiO₂ + | CuHPO₃ + CaHPO₃: 125 ppm** | |
| Prussian blue | (30) | |
| | TiO₂: 125 ppm (3) | |
| | Prussian blue: 125 ppm (5) | |
| IR6141 + CuHPO₃ + | IR6141: 5 ppm (45) | 100 (91) |
| *ZnO | CuHPO₃: 125 ppm** (32) | |
| | ZnO: 125 ppm (14) | |
| IR6141 + CuHPO₃ + | IR6141: 5 ppm (45) | 100 (85) |
| Copper phthalocyanine | CuHPO₃ : 125 ppm** (32) | |
| | Copper phthalocyanine: 32 ppm*** | |
| | (8) | |
| IR6141 + CuHPO₃ + | IR6141: 5 ppm (45) | 100 (91) |
| ZnHPO₃ (1:1) + *ZnO + | CuHPO₃ + ZnHPO₃: 125 ppm** | |
| Prussian blue | (27) | |
| | ZnO: 125 ppm (14) | |
| | Prussian blue: 125 ppm (5) | |
| IR6141 + ZnHPO₃ + | IR6141: 5 ppm (45) | 100 (68) |
| Prussian blue | ZnHPO₃: 125 ppm** (18) | |
| | Prussian blue: 125 ppm (5) | |
| IR6141 + CuHPO₃ + Ca—HPO₃ | IR6141: 5 ppm (45) | 100 (95) |
| (1:1) + *ZnO + | CuHPO₃ + CaHPO₃: 125 ppm** | |
| Prussian blue | (31) | |
| | ZnO: 125 ppm (14) | |
| | Prussian blue: 125 ppm (5) | |
| Cu(ASA)₂ + CuHPO₃ + | Cu(ASA)₂: 32 ppm*** (45) | 100 (80) |
| *TiO₂ | CuHPO₃: 125 ppm** (32) | |
| | TiO₂: 125 ppm (3) | |
| Cu(ASA)₂ + CuHPO₃ + | Cu(ASA)₂: 32 ppm*** (45) | 100 (91) |
| *ZnO | CuHPO₃: 125 ppm** (32) | |
| | ZnO: 125 ppm (14) | |
| Cu(ASA)₂ + CuHPO₃ + | Cu(ASA)₂: 32 ppm*** (45) | 100 (78) |
| CaHPO₃ (1:1) *TiO₂ | CuHPO₃ + CaHPO₃: 125 ppm** | |
| | (30) | |
| | TiO₂: 125 ppm (3) | |
| Cu(ASA)₂ + CuHPO₃ + | Cu(ASA)₂: 32 ppm*** (45) | 100 (85) |
| *TiO₂ + Prussian blue | CuHPO₃: 125 ppm** (32) | |
| | TiO₂: 125 ppm (3) | |
| | Prussian blue: 125 ppm (5) | |
| Cu(ASA)₂ + CuHPO₃ + | Cu(ASA)₂: 32 ppm*** (45) | 100 (96) |
| *ZnO + Prussian blue | CuHPO₃: 125 ppm** (32) | |
| | ZnO: 125 ppm (14) | |
| | Prussian blue: 125 ppm (5) | |
| Cu(ASA)₂ + CuHPO₃ + | Cu(ASA)₂: 32 ppm*** (45) | 100 (80) |
| ZnHPO₃ (1:1) + *TiO₂ + | CuHPO₃ + ZnHPO₃: 125 ppm** | |
| Prussian blue | (27) | |
| | TiO₂: 125 ppm (3) | |
| | Prussian blue: 125 ppm (5) | |
| Cu(ASA)₂ + CuHPO₃ + | Cu(ASA)₂: 32 ppm*** (45) | 100 (85) |
| Copper phthalocyanine | CuHPO₃: 125 ppm** (32) | |
| | Copper phthalocyanine: 32 ppm*** | |
| | (8) | |
| Cu(SA) + CuHPO₃ + | Cu(SA): 32 ppm*** (42) | 99 (77) |
| *TiO₂ | CuHPO₃: 125 ppm** (32) | |
| | TiO₂: 125 ppm (3) | |
| Cu(SA) + CuHPO₃ + | Cu(SA): 32 ppm*** (42) | 100 (88) |
| *ZnO | CuHPO₃: 125 ppm** (32) | |
| | ZnO: 125 ppm (14) | |
| Cu(SA) + CuHPO₃ + | Cu(SA): 32 ppm*** (42) | 99 (75) |
| CaHPO₃ (1:1) *TiO₂ | CuHPO₃ + CaHPO₃: 125 ppm** | |
| | (30) | |
| | TiO₂: 125 ppm (3) | |
| Cu(SA) + CuHPO₃ + | Cu(SA): 32 ppm*** (42) | 99 (83) |
| *TiO₂ + Prussian blue | CuHPO₃: 125 ppm** (32) | |
| | TiO₂: 125 ppm (3) | |
| | Prussian blue: 125 ppm (5) | |
| Cu(SA) + CuHPO₃ + | Cu(SA): 32 ppm*** (42) | 100 (93) |
| *ZnO + Prussian blue | CuHPO₃: 125 ppm** (32) | |
| | ZnO: 125 ppm (14) | |
| | Prussian blue: 125 ppm (5) | |
| Cu(SA) + CuHPO₃ + | Cu(SA): 32 ppm*** (42) | 99 (80) |
| ZnHPO₃ (1:1) + *TiO₂ + | CuHPO₃ + ZnHPO₃: 125 ppm** | |
| Prussian blue | (27) | |
| | TiO₂: 125 ppm (3) | |
| | Prussian blue: 125 ppm (5) | |
| Cu(SA) + CuHPO₃ + | Cu(SA): 32 ppm*** (42) | 99 (82) |
| Copper phthalocyanine | CuHPO₃: 125 ppm** (32) | |
| | Copper phthalocyanine: 32 ppm*** | |
| | (8) | |

*The oxides used have a maximum particle-size of 0.15 microns
**The dose is expressed in ppm of equivalent phosphorous acid.
***The dose is expressed in ppm of equivalent metal copper.

1. Synergistic mixtures comprising at least one compound belonging to each of the following groups:
A. phosphorous acid and/or one or more salts of phosphorous acid, also called phosphites or phosphonates (defined as FOS) and
B. synergizing compounds (defined as SIN)

2. The mixtures according to claim 1, characterized in that the salts of phosphorous acid are selected from the salt of an alkaline, alkaline earth metal, an ammonium salt or a salt of Cu, Fe, Mn, Zn, Ni, Al, Ti, Se.

3. The mixtures according to claim 1, characterized in that the salts of an alkaline, alkaline earth metal, the ammonium salt or salts of Cu, Fe, Mn, Zn, Ni, Al, Ti, Se, of phosphorous acid are mono- or di-basic, or a mixtures thereof in any proportion.

4. The mixtures according to claim 1, characterized in that the SIN compounds are selected from products with a zero or low direct fungicidal activity, having intrinsic photocatalytic properties.

5. The mixtures according to claim 1, characterized in that the SIN compounds are selected from one of the following groups a and b : a: titanium dioxide, zinc oxide or zinc salts, such as for example, zinc sulfate, zinc nitrate, zinc chloride,zinc titanate, zirconium dioxide, silica, silicic acid; b: pigments and dyes, such as for example, Prussian blue, Bengal pink, phthalocyanines, metal porphyrins, natural or synthesis optical bluing agents.

6. The mixtures according to claim 5, characterized in that the phthalocyanines are selected from copper phthalocyanine, zinc phthalocyanine, iron phthalocyanine.

7. The mixtures according to claim 5, characterized in that the metal porphyrins are selected from chlorophyll and chlorophyllines.

8. The mixtures according to claim 5, characterized in that the natural or synthesis optical bluing agents refer to compounds such as for example, esculetin, esculin, um-belliferone and stilbene derivatives.

9. The mixtures according to claim 5, characterized in that the SIN compounds are applied, when solid, in mi-cronized form with a particle-size of less than a micron.

10. The mixtures according to claim 9, characterized in that the SIN compounds are applied in the form of nano-particles or in the colloidal form.

11. The mixtures according to claim 1, characterized in that they are selected from:
copper (II) salt of phosphorous acid+titanium dioxide;
copper (II) salt of phosphorous acid+zinc oxide;
copper (II) salt of phosphorous acid+silicic acid;
copper (II) salt of phosphorous acid+Prussian blue;
copper (II) salt of phosphorous acid+titanium dioxide+Prussian blue;
copper (II) salt of phosphorous acid+zinc oxide+Prussian blue;
zinc salt of phosphorous acid+titanium dioxide; zinc salt of phosphorous acid+silicic acid;
zinc salt of phosphorous acid+Prussian blue;
copper (II) salt of phosphorous acid+calcium salt of phosphorous acid+titanium dioxide;
copper (II) salt of phosphorous acid+zinc salt of phosphorous acid+titanium dioxide;
copper (II) salt of phosphorous acid+calcium salt of phosphorous acid+zinc oxide,
copper (II) salt of phosphorous acid+zinc salt of phosphorous acid+zinc oxide,
copper (II) salt of phosphorous acid+zinc salt of phosphorous acid+Prussian blue;
copper (II) salt of phosphorous acid+zinc salt of phosphorous acid+Prussian blue+titanium dioxide;
copper (II) salt of phosphorous acid+calcium salt of phosphorous acid+Prussian blue+titanium dioxide;
copper (II) salt of phosphorous acid+zinc salt of phosphorous acid+copper phthalocyanine,
copper (II) salt of phosphorous acid+manganese (II) salt of phosphorous acid+esculin.

12. The mixtures according to claim 1, characterized in that they also contain salts of alkaline metals in percentages not higher than 10% by weight, as reaction exchange salts which however do not have a direct fungicidal activity.

13. Use of synergistic mixtures comprising at least one compound belonging to each of the following groups:
A. phosphorous acid and/or one or more salts of phosphorous acid, also called phosphites or phosphonates (defined as FOS) and
B. synergizing compounds (defined as SIN) as fungicidal mixtures for the control of phytopathogen fungi in agricultural crops.

14. (canceled)

15. A process for the preparation of synergistic mixtures according to claim 1, characterized in that it comprises the mixing of the single salts, or the co-precipitation of said salts in a reaction mixture.

16. The process according to claim 15, characterized in that the metallic salts of phosphorous acid are present in any proportion, solvatation state, structure and composition of the crystalline lattice.

17. Fungicidal compositions comprising synergistic mixtures according to claim 1, characterized in that they comprise at least a further component having a fungicidal activity.

18. The compositions according to claim 17, characterized in that the component having a fungicidal activity is selected from:
(1) IR5885, a dipeptide compound corresponding to di-astereoisomeric mixtures of methyl [S—(R,S)]-[3-(N-isopropoxycarbonylvalinyl)-amino]-3-(4-chloro-phenyl)propanoate in any proportion, or to one of the two diastereoisomeric forms S—R or S—S taken individually;
(2) IR6141, corresponding to methyl N-(phenylacetyl)-N-2,6-xylyl-R-alaninate;
(3) Salicylic acid (SA) or its derivatives such as acetylsalicylic acid (ASA), copper salts of salicylic acid or acetylsalicylic acid;
(4) A copper (I) or copper (II) salt, such as copper oxychloride, copper hydroxide, Bordeaux mixture, copper sulfate, or a mixture of copper hydroxide and oxychloride (Airone); (5) Benalaxyl corresponding to methyl N-(phenyl-acetyl)-N-2,6-xylyl-RS-alaninate; (6) Metalaxyl corresponding to methyl N-(2-methoxyacetyl)-N-2,6-xylyl-RS-alaninate;
(7) Metalaxyl-M corresponding to methyl N-(2-methoxyacetyl)-N-2,6-xylyl-R-alaninate;
(8) Oxadixyl corresponding to 2-methoxy-N-(2-oxo-1,3-oxazolidin-3-yl)aceto-2′,6′-xylidide;
(9) Ofurace corresponding to DL-3-[N-chloroacetyl-N-(2,6-xylyl)-amino]-γ-butyrolactone;
(10) Iprovalicarb corresponding to O-1-methyl-ethyl)-N-[2-methyl-1-[[[1-(4-methyl-phenyl)-ethyl]amino]carbonyl]propyl]carbamate;
(11) Benthiavalicarb-isopropyl corresponding to 0-isopropyl[(S)-1-{[(IR)-1-(6-fluoro-1,3-benzo-thiazol-2-yl)ethyl]-carbamoyl-2-methylpropyl]-carbamate; (12) Cymoxanil corresponding to 1-(2-cyano-2-methoxyimino-acetyl)-3-ethylurea;
(13) Azoxystrobin corresponding to methyl (E)-2-[2-[6-(2-cyanophenoxy)-pyrimidin-4-yloxy]phenyl-3-methoxyacrylate;
(14) Metominofen corresponding to N-methyl-(E)-methoxyimino-(2-phenoxyphenyl)acetamide;
(15) Pyraclostrobin corresponding to methyl N-(2-[1-(4-chlorophenyl)pyrazol-3yloxymethyl]-phenyl)-N-methoxycarbamate;
(16) Acibenzolar-S-methyl corresponding to methyl benzo(1,2,3)thiadiazole-7-thiocarboxylate;
(17) Famoxadone corresponding to 5-methyl-5-(4- phenoxyphenyl)-3-(phenylamino)oxazolidin-2,4-dione;
(18) Fenamidone corresponding to 4-methyl-4-phenyl-1-(phenylamino)-2-methylthioimidazolidin-5-one;
(19) Cyazofamide, corresponding to 2-cyano-4-chloro-5-(4-methylphenyl)-1-(N,N-dimethylamino-sulfamoyl)imidazole;
(20) Fluazinam corresponding to 3-chloro-N-(3-chloro-5-trifluoromethyl-2-pyridyl)-α-α-α-trifluoro-2,6-dinitro-p-toluidine;
(21) Dimethomorph corresponding to (E,Z)-4-[3-(4-chlorophenyl)-3-(3,4-dimethoxyphenyl)-acryloyl]morpholine,- or Flumorph (SYP-L190) corresponding to (E,Z)-4-[3-(4-fluorophenyl)-3-(3,4-dimethoxyphenyl)-acryloyl]morpholine;
(22) Flumetover corresponding to N,N-diethylamide of 4-trifluoromethyl-6-3,4-dimethoxyphenyl)-benzoic acid;
(23) Chlorothalonil corresponding to 1,3-dicyano-2,4,5-tetrachlorobenzene;
(24) Mancozeb corresponding to the manganese and zinc salt of ethylenebis(dithiocarbamate) (polymer);
(25) Tolylfluanide corresponding to N-dichloro-fluoromethylthio-N′,N′-dimethyl-N-p-tolylsulfamide,
(26) Folpet corresponding to N-(trichloromethyl-thio)phthalimide;
(27) Etridiazole corresponding to ethyl-3-trichloromethyl-1,2,4-thiadiazolyl ether;
(28) Hymexanol corresponding to 5-methyliso-oxazol-3-ol;
(29) Propamocarb corresponding to propyl-(3-dimethylaminopropyl)carbamate;
(30) R-3-aminobutanoic acid or RS-3-aminobutanoic acid;
(31) Zoxamide, corresponding to 3,5-dichloro-N-(3-chloro-1-ethyl-1-methyl-2-oxopropyl)-p-toluamide;
(32) 2-(4-chlorophenyl)-N-[2-(3-methoxy-4-prop-2-inyloxy-phenyl)ethyl]-2-prop-2-inyloxyacetamide;
(33) Ethaboxam, (RS)-(α-cyano-2-thienyl)-4-ethyl-2(ethyl-amino)-5-thiazolecarboxyamide.

19. The compositions according to claim 17, characterized in that they are selected from:
IR5885+copper (II) salt of phosphorous acid+titanium dioxide;
IR5885+copper (II) salt of phosphorous acid+zinc oxide;—IR5885 copper (II) salt of phosphorous acid+copper phthalocyanine;
IR5885 copper (II) salt of phosphorous acid+Prussian blue;
IR5885+zinc salt of phosphorous acid+zinc oxide;
IR5885+copper (II) salt of phosphorous acid+calcium salt of phosphorous acid+titanium dioxide;
IR5885+copper (II) salt of phosphorous acid+zinc salt of phosphorous acid+titanium dioxide;
IR5885+copper (II) salt of phosphorous acid+calcium salt of phosphorous acid+zinc oxide;
IR5885+copper (II) salt of phosphorous acid+calcium salt of phosphorous acid+Prussian blue+titanium dioxide;
IR5885+copper (II) salt of phosphorous acid+titanium dioxide+Prussian blue;
IR5885+copper (II) salt of phosphorous acid+zinc oxide+Prussian blue;—IR6141+copper (II) salt of phosphorous acid+zinc oxide;
IR6141 copper (II) salt of phosphorous acid+copper phthalocyanine;
IR6141 zinc salt of phosphorous acid+Prussian blue;
IR6141+copper (II) salt of phosphorous acid+zinc salt of phosphorous acid+Prussian blue+zinc oxide;
IR6141+copper (II) salt of phosphorous acid+calcium salt of phosphorous acid+Prussian blue+zinc oxide;
Cu(ASA)₂+copper (II) salt of phosphorous acid+titanium dioxide;
Cu(ASA)₂+copper (II) salt of phosphorous acid+zinc oxide,
Cu(ASA)₂+copper (II) salt of phosphorous acid+silicic acid;
Cu(ASA)₂+copper (II) salt of phosphorous acid+copper phthalocyanine;—Cu(ASA)₂+copper (II) salt of phosphorous acid+Prussian blue;
Cu(ASA)₂+zinc salt of phosphorous acid+titanium dioxide;
Cu(ASA)₂+zinc salt of phosphorous acid+Prussian blue;
Cu(ASA)₂+copper (II) salt of phosphorous acid+calcium salt of phosphorous acid+titanium dioxide;
Cu(ASA)₂+copper (II) salt of phosphorous acid+zinc salt of phosphorous acid+titanium dioxide;
Cu(ASA)₂+copper (II) salt of phosphorous acid+calcium salt of phosphorous acid+zinc oxide;
Cu(ASA)₂+copper (II) salt of phosphorous acid+calcium salt of phosphorous acid+Prussian blue;—Cu(ASA)₂+copper (II) salt of phosphorous acid+zinc salt of phosphorous acid+Prussian blue+titanium dioxide;
Cu(ASA)₂+copper (II) salt of phosphorous acid+calcium salt of phosphorous acid+copper phthalocyanine,
Cu(ASA)₂+copper (H) salt of phosphorous acid+manganese (II) salt of phosphorous acid+copper phthalocyanine;
Cu(ASA)₂+copper (II) salt of phosphorous acid+zinc salt of phosphorous acid+esculin;
Cu(ASA)₂+copper (II) salt of phosphorous acid+Prussian blue+titanium dioxide;
Cu(ASA)₂+copper (II) salt of phosphorous acid+Prussian blue+zinc oxide;
Cu(SA)+copper (II) salt of phosphorous acid+titanium dioxide;
Cu(SA)+copper (II) salt of phosphorous acid+zinc oxide;
Cu(SA)+copper (II) salt of phosphorous acid+silica;
Cu(SA)+copper (II) salt of phosphorous acid+silicic acid;
Cu(SA)+copper (II) salt of phosphorous acid+copper phthalocyanine;—Cu(SA)+zinc salt of phosphorous acid+titanium dioxide;
Cu(SA)+zinc salt of phosphorous acid+silicic acid;
Cu(SA)+copper (II) salt of phosphorous acid+calcium salt of phosphorous acid+titanium dioxide;
Cu(SA)+copper (II) salt of phosphorous acid+titanium dioxide+Prussian blue;
Cu(SA)+copper (II) salt of phosphorous acid+zinc oxide+Prussian blue;
Cu(SA)+copper (II) salt of phosphorous acid+zinc salt of phosphorous acid+titanium dioxide+Prussian blue.

20. Use of compositions according to claim 17 for the control of phytopathogen fungi in agricultural crops.

21. Use according to claim 13, characterized in that the synergistic mixture or composition is formulated in the form of dry powders, wettable powders, emulsifying concentrates, micro-emulsions, pastes, granu-lates, solutions, suspensions.

22. Use according to claim 13, characterized in that the phytopathogen fungi are fungi which attack crops of vines, tobacco, sugar beet, cereals, vegetables, rice, cucurbits, fruit trees. 23. Use according to one of claim 13 or 20 for both treatment and prevention.

24. Use according to claim 13, wherein the doses of each compound, selected from those defined as 25. FOS and SIN, range from 0.5 g to 5 kg per hectare.

25. A method for the control of phytopathogen fungi in agricultural crops by the application of synergistic mixtures comprising at least one compound belonging to each of the following groups: A. phosphorous acid and/or one or more salts of phosphorous acid, also called phosphites or phosphonates (defined as FOS) and B. synergizing compounds (defined as SIN), or by the application of synergistic compositions comprising said mixtures and one or more fungicidal compounds (1)-(33)

26. The method according to claim 25, characterized in that the application is effected on all parts of the plant, or on the seeds themselves before being planted, or on the ground in which the plant grows.

27. The method according to claim 25, characterized in that the mixture or composition also comprises other compatible active principles such as, for example, other fungicides, phytoregulators, antibiotics, herbicides, insecticides and fertilizers.

28. The method according to claim 27, characterized in that the concentration of active principle (s) ranges from 1% to 90%, preferably from 5 to 50%.
